(19) United States
(12) Patent Application Publication
(10) Pub. No.: US 2021/0055061 A1
(43) Pub. Date: Feb. 25, 2021

(54) DEVICE FOR FLEXIBLY SEPARATING COLD AND HOT FLUID MEDIA

(71) Applicant: Shandong University, Jinan (CN)

(72) Inventors: Kuihua Han, Jinan (CN); Jianhui Qi, Jinan (CN); Ming Gao, Jinan (CN)

(21) Appl. No.: 16/998,255

(22) Filed: Aug. 20, 2020

(30) Foreign Application Priority Data
Aug. 22, 2019 (CN) 201910778196.X

(51) Int. Cl. F28D 20/00

(52) U.S. Cl. CPC F28D 20/0039; F28D 2020/0091

(57) ABSTRACT

A device for flexibly separating cold and hot fluid media, including: a tank body, where the tank body is cylindrical and disposed vertically, upper and lower ends of the tank body are respectively provided with a hot fluid inlet and a cold fluid inlet to provide storage space for hot and cold fluids, at least one adsorption layer is provided on a side wall of the tank body, and the adsorption layer is made of a ferromagnetic material or iron; and a thermal insulation board, where the thermal insulation board is of a plate structure and set on a horizontal cross-section of the tank body, with a shape and area matching a horizontal cross-section of the tank body, a sealing strip is arranged along a circumferential direction of the thermal insulation board, the sealing strip is of a hollow structure, the hollow part is evenly filled with adsorption blocks.

### REFERENCE TO RELATED APPLICATION

This application claims foreign priority to Chinese Patent Application No. CN201910778196.X, filed on Aug. 22, 2019, the entire contents of which are incorporated herein by reference.

### TECHNICAL FIELD

The present invention relates to the field of energy storage technologies, and in particular, to a device for flexibly separating cold and hot fluid media.

### BACKGROUND OF THE INVENTION

Information for disclosing this background section is only for the purpose of increasing understanding of the general background of the present invention, and is not necessarily regarded as an acknowledgement or any form of suggestion that the information constitutes the prior art already known to those of ordinary skill in the art.

The thermal storage system can be used for unit peak load regulation, cogeneration, wind-PV power generation, and efficient use of solar heat and industrial waste heat, and is significant to peak cut, multi-energy complementation, energy saving, and energy efficiency improvement.

Hot and cold water tanks are mainly used in the field of sensible heating and cooling. Based on different densities of cold and hot water, naturally stratified water storage tanks are used. The water distributor in the hot water tank makes the cold and hot water flow evenly from the bottom and the top of the tank, forming a stable thermocline at the junction of the cold and hot water. The thermocline is a relatively thin transition layer that has a relatively small mixing effect of cold and hot water. The upper part of the thermocline is hot water, and the lower part of the thermocline is cold water. The thermocline moves up and down with the inflow and outflow of hot and cold water, to implement heat storage and heat release. For naturally stratified water storage tanks, the thickness of the thermocline affects the heat storage efficiency. The thicker the thermocline, the lower the heat storage efficiency and the less hot water that meets the heating temperature conditions. Generally, the disturbance of the water in the tank by the inlet water flow is reduced by optimizing the design of the top and bottom water distributors, thereby reducing the thickness of the thermocline and improving the heat storage efficiency.

However, no matter how the water distributors are optimized, the thermocline has a considerable thickness due to the temperature difference and heat conduction. In addition, openings need to be provided on the water distributors, and the number of the water distributors need to be optimized through numerical simulation. When the cross-section of the tank is large, multi-tube water distributors are used, with unequal spacings of the water distribution pipe openings, to achieve equal water distribution areas of the water distribution pipes to reduce disturbances and achieve approximately uniform low-speed flows. However, the water distributor and opening processing is complicated, and it is difficult to greatly reduce the thickness of the thermocline and increase the efficiency of the heat storage system through optimization of the water distributors.

Chinese patent 201210379993.9 proposes a single-tank heat storage system and a single-tank heat storage method. A floating thermal insulation board and a balancing weight are introduced into the hot water tank. The system relies on a large number of pumps and valves, the mechanism is complex, the floating thermal insulation board has fixed gravity, but the temperature change of the heat storage fluid causes the density change, which leads to continuous changes in the buoyancy on the floating thermal insulation board in the fluid. The balancing weight of the floating thermal insulation board is fixed, making it difficult to achieve continuous adjustment in response to the buoyancy of the floating thermal insulation board. As a result, it is difficult to implement automatic rise and fall of the floating thermal insulation board.

Chinese patent 201610608374.0 proposes a thermocline heat storage device for liquid heat storage. A thermal insulation board is made of heat insulation material, with a sealing ring installed on its outer edge. The sealing ring of the thermal insulation board is closely attached to the inner wall of a hot water tank. The sealing ring is used to block the heat storage liquid from flowing in a gap between the thermal insulation board and the hot water tank. The thermal insulation board divides the hot water tank into an upper cavity and a lower cavity that are independently sealed. The thermal insulation board is penetrated with a bolt and a guide rod. The bolt passes through the central hole of the thermal insulation board vertically, and is connected with the central hole through threads. The center line of the bolt coincides with the center line of the hot water tank. The upper end of the bolt is connected to the lower end of a rotating shaft of a reducer through a magnetic drive coupling. The lower end of the bolt is connected in parallel to a guide rod and a bolt on the bottom surface of the hot water tank through a screw bearing. The rod passes through the through hole reserved for the thermal insulation board. The through hole is provided between the center hole and the edge of the thermal insulation board. A guide rod sealing ring is installed in the through hole, and the guide rod passes vertically through the center hole of the sealing ring. The sealing ring is used to block the heat storage liquid from flowing in a gap between the thermal insulation board and the guide rod. The lower end of the guide rod is fastened to the lower bottom surface of the hot water tank. The variable-frequency motor can drive the reducer through the coupling. The reducer enables the variable-frequency motor to change from high-speed rotation to low-speed and high-torque rotation. The reducer drives the bolt to rotate through the magnetic drive coupling. The thermal insulation board is driven by the bolt to move up or down, so as to drive the cold and hot fluids by changing the volumes of the upper cavity and the lower cavity of the hot water tank. Obviously, the tank structure, device sealing, and driving device of the device are complicated and costly.

Chinese patent 201811198191.1 proposes a heat storage device for forced stratification, which is provided with a floating plate suitable for floating in the heat storage medium. The floating plate is movably assembled in a vertical direction relative to the inner wall of a tank. Above the floating plate is a first temperature zone, and below the floating plate is a second temperature zone. The first temperature zone and the second temperature zone communicate. The density of the floating plate is greater than the density of the heat storage medium in the first temperature zone and smaller than the density of the heat storage medium in the second temperature zone. The density p of the floating plate satisfies: 950 kg/m³≤ρ≤990 kg/m³. There is a gap between the floating plate and the inner wall of the tank, so that the first temperature zone and the second temperature zone communicate. Obviously, the floating plate only meets the requirement of floating at the junction of the cold and hot fluids based on gravity and buoyancy. However, the density of water varies with the temperature: 999.972 kg/m³ at 4° C., 997.043 kg/m³ at 25° C., 992.212 kg/m³ at 40° C., 990.208 kg/m³ at 40.5° C., 971.785 kg/m³ at 80° C., and 958.345 kg/m³ at 100° C. Obviously, it is not suitable for cold water tanks. The material properties and preparation process must meet certain requirements to ensure that the floating plate meets both the density requirement and the thermal insulation requirements. However, this patent does not mention the details of the material. It does not mention the gap size between the floating plate and the inner wall of the tank or the sealing. The disturbance and mixing of cold and hot fluids are inevitable.

### SUMMARY OF THE INVENTION

In view of the prior-art problems, the present invention is intended to provide a device for flexibly separating cold and hot fluid media. This device relies on buoyancy, gravity, magnetic force, and friction to keep a thermal insulation board at the junction between the cold and hot fluid media and closely attached to the inner wall of a storage tank to separate the hot and cold fluids. The thermal insulation board is simple in structure and low in cost.

To resolve the foregoing technical problems, the technical solution adopted by the present invention is as follows:

A device for flexibly separating cold and hot fluid media, including:

a tank body, where the tank body is cylindrical and disposed vertically; upper and lower ends of the tank body are respectively provided with a hot fluid inlet and a cold fluid inlet to provide storage space for hot and cold fluids; at least one adsorption layer is provided on a side wall of the tank body, and the adsorption layer is made of a ferromagnetic material or iron; and

a thermal insulation board, where the thermal insulation board is of a plate structure and set on a horizontal cross-section of the tank body, with a shape and area matching a horizontal cross-section of the tank body; where

a sealing strip is arranged along a circumferential direction of the thermal insulation board, where the sealing strip is of a hollow structure, and the hollow part is evenly filled with adsorption blocks, the adsorption blocks are made of a ferromagnetic material or iron, and attraction is generated between the adsorption layer and the adsorption blocks; and

a working surface area of the body of the thermal insulation board is smaller than the horizontal cross-section of the tank body.

A magnetic attraction is generated between the adsorption blocks arranged around the thermal insulation board and the adsorption layer on a side wall of the tank body, so that the thermal insulation board is subject to gravity, buoyancy, frictional force of the side wall of the tank body, and magnetic force in the fluid in the tank. The resultant force of these forces enables the thermal insulation board to stay at any horizontal cross-section of the tank body. When the cold and hot fluids flow in or out, the strong impact of the fluids drives the thermal insulation board to move towards the side where the fluids are discharged, which enables the thermal insulation board to respond to the inflow or outflow of the cold and hot fluids.

The sealing strip around the thermal insulation board is evenly filled with adsorption blocks, that is, the adsorption blocks are evenly distributed along the circumferential direction of the thermal insulation board. Therefore, the thermal insulation board tends to become level under the magnetic force between the adsorption blocks and the adsorption layer. This tendency enables the thermal insulation board to become level in time, that is, to stay closely attached to the inner wall of the tank body, under the uneven impact force of the cold and hot fluids. This prevents the mixing of the cold and hot fluids, and therefore poses lower performance requirements on hot and cold fluid nozzles and reduces costs.

The adsorption blocks around the thermal insulation board are filled in the sealing strip. The sealing strip is generally made of elastic material. The adsorption blocks and the adsorption layer of the tank body tend to fit closely due to the magnetic attraction, leaving the sealing strip exactly stuck between them. This facilitate the sealed state between the thermal insulation board and the inner wall of the tank body, prevents the mixing of the cold and hot fluids, and improves the heat insulation effect of the cold and hot fluids.

In some examples, the hot fluid inlet is provided with a first water distributor, and the cold fluid inlet is provided with a second water distributor, where the first water distributor and the second water distributor are respectively connected to a hot fluid source and a cold fluid source.

Further, both the first water distributor and the second water distributor are coaxial with the tank body.

Both the first water distributor and the second water distributor are coaxial with the tank body, so that the input hot and cold fluids enter the tank body along the middle of the tank body, and diffuse when they flow. During the diffusion process, a relatively symmetrical force is applied to the thermal insulation board, preventing it from shaking violently while the hot and cold fluids flow in or out.

In some examples, the thickness of the thermal insulation board ranges from 5 mm to 100 mm.

In some examples, the thermal insulation board has a heat conductivity coefficient ranging from 0.02 W to 0.5 W/(m·K), and is resistant to a low temperature resistance of −60° C. and a high temperature of 250° C.

The material of the thermal insulation board should be insulated and waterproof material with high thermal stability.

Further, the thermal insulation board is a polycarbonate endurance board or a silicone foam board.

In some examples, the material of the sealing strip is elastic.

Further, the sealing strip is a silicone foam sealing strip, and a cross-section area of the hollow part of the sealing strip is larger than a cross-section area of the adsorption block.

If a hard material area of the thermal insulation board completely covers the horizontal cross-section of the tank body, the thermal insulation board is easily stuck on a side wall of the tank body during the movement. In the present invention, the working surface area of the thermal insulation board body is designed to be smaller than the horizontal cross-sectional area of the tank body, and the sealing strip is properly stretched by the magnetic force between the adsorption blocks and the adsorption layer, to achieve a sealing effect and generate friction. This design can effectively prevent the thermal insulation board from being stuck and allow the thermal insulation board to respond to the inflow and outflow of the fluids in time.

In some examples, a surface of the sealing strip in contact with the side wall of the tank body is a curved surface.

In some examples, the sealing strip and the board body are fixed through one or any combination of hot melting, impaction, gluing, seam, snap-fit, or screwing.

In some examples, the ferromagnetic material is a neodymium iron boron magnet or a samarium cobalt magnet. The neodymium iron boron magnet operates at 80-200° C., and the samarium cobalt magnet can withstand a high temperature of 350° C. These two materials can work at a high temperature. An appropriate material can be selected according to the working temperature of the heating medium.

Further, the adsorption block is a flexible magnet strip. The flexible magnet strip can closely fit the inner wall of the tank body easily to improve the sealing performance of the thermal insulation board.

In some examples, the adsorption blocks are arranged along the circumferential direction of the thermal insulation board to completely cover the circumference of the thermal insulation board, or are evenly distributed along the circumferential direction of the thermal insulation board and cover more than ⅓ of the circumference of the thermal insulation board.

The present invention has the following beneficial effects.

According to the device for flexibly separating cold and hot fluid media of the storage tank of the present invention, the sealing strip is tightly attached to the wall of the tank through tension and magnetic force, which effectively inhibits the mixing of cold and hot media. Relying on the buoyancy, gravity, magnetic force and friction, the device remains fixed at the cold and hot junction, and moves with the movement of the cold and hot junction when the cold or hot media flows in or out of the tank. The device can isolate the hot and cold media flexibly, and significantly reduce the mixing of the hot and cold media. When the hot and cold media flow in or out, even if disturbance occurs, the device can effectively suppress the mixing of the cold and heat media, greatly reduce the thickness of the thermocline, and effectively inhibit the mixing of the high temperature medium and low temperature medium. The device has a simple structure without additional active support. It features easy installation and maintenance, stable and reliable operation, low cost, and energy conservation.

The present invention is particularly suitable for the hot water tanks and cold water tanks of the heating and cooling systems in areas such as cogeneration, deep peak load regulation, and valley power utilization.

### BRIEF DESCRIPTION OF THE DRAWINGS

The accompany drawings of the specification constituting a part of the present application provide further understanding of the present application. The schematic examples of the present application and description thereof are intended to be illustrative of the present application and do not constitute an undue limitation of the present application.

FIG. 1 is a schematic structural diagram of a hot water tank and a heat insulation device according to an example of the present invention.

FIG. 2 is a schematic structural diagram of four types of thermal insulation boards according to an example of the present invention.

FIG. 3 is a schematic structural diagram of a horizontal cross-section of a sealing strip according to an example of the present invention.

FIG. 4 is a schematic structural diagram of the arrangement of magnets in the sealing strip according to an example of the present invention.

In the figure, 1. insulation layer, 2. inner wall, 3. thermal insulation board, 4. sealing strip, 5. magnet, 6. first water distributor, 7, second water distributor, 8. overflow valve, 9. safety valve, 10. drain valve, 11. temperature measuring point at hot water outlet, 12. hot water valve, 13. temperature measuring point at cold water outlet, and 14. cold water valve.

### DETAILED DESCRIPTION OF THE INVENTION

It should be noted that the following detailed description is exemplary and aims to further describe the present application. Unless otherwise specified, all technical and scientific terms used herein have the same meaning as commonly understood by persons of ordinary skill in the technical field to which the present application belongs.

It should be noted that the terms used herein are merely used for describing the specific examples, but are not intended to limit exemplary examples of the present invention. As used herein, the singular form is also intended to include the plural form unless otherwise indicated obviously from the context. Furthermore, it should be further understood that the terms “include” and/or “comprise” used in this specification specify the presence of stated features, steps, operations, elements, components and/or a combination thereof.

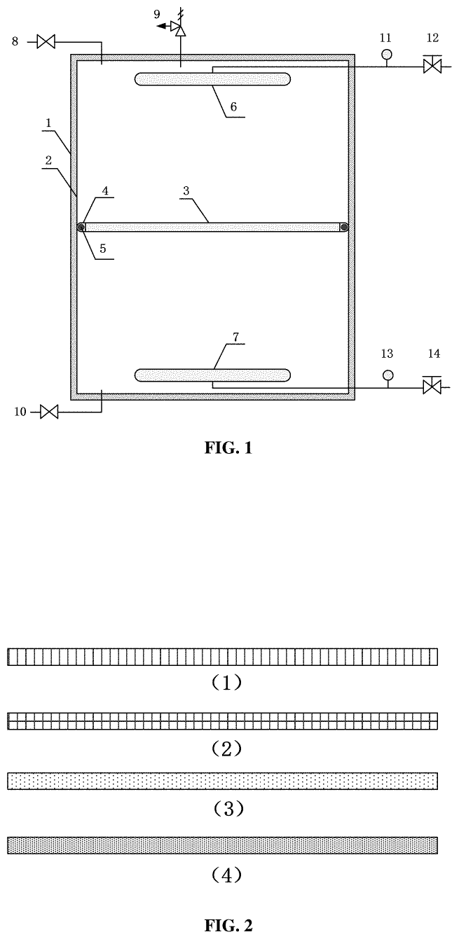

As shown in FIG. 1, a device for flexibly separating cold and hot fluid media according to an example of the present invention includes: a tank body, a thermal insulation board 3, a first water distributor 6, and a second water distributor 7.

The tank body is cylindrical and disposed vertically. Upper and lower ends of the tank body are respectively provided with a hot fluid inlet and a cold fluid inlet to provide storage space for hot and cold fluids. The hot fluid inlet is provided with a first water distributor 6, and the cold fluid inlet is provided with a second water distributor 7. The first water distributor 6 and the second water distributor 7 are respectively connected to a hot fluid source and a cold fluid source. Both the first water distributor 6 and the second water distributor 7 are coaxial with the tank body. A temperature measuring point 11 at a hot water outlet and a hot water valve 12 are provided on a connecting pipe between the first water distributor 6 and the hot fluid source. A temperature measuring point 13 at a cold water outlet and a cold water valve 14 are provided on a connecting pipe between the second water distributor 7 and the cold fluid source.

The side wall of the tank body includes an outer thermal insulation layer and an inner wall, and the inner wall is made of iron or ferromagnetic material. An overflow valve 8 and a safety valve 9 are provided on the top of the tank body, a drain pipe is provided at the bottom of the tank body, and a drain valve 10 is provided on the drain pipe.

The thermal insulation board 3 is of a plate structure and set on a horizontal cross-section of the tank body, with a shape and area matching a horizontal cross-section of the tank body. A sealing strip 4 is arranged along the circumferential direction of the thermal insulation board 3. The sealing strip 4 is of a hollow structure, and the hollow part is evenly filled with adsorption blocks. The adsorption blocks are made of a ferromagnetic material or iron, and attraction is generated between the adsorption layer and the adsorption blocks. A working surface area of the body of the thermal insulation board 3 is smaller than the horizontal cross-section of the tank body.

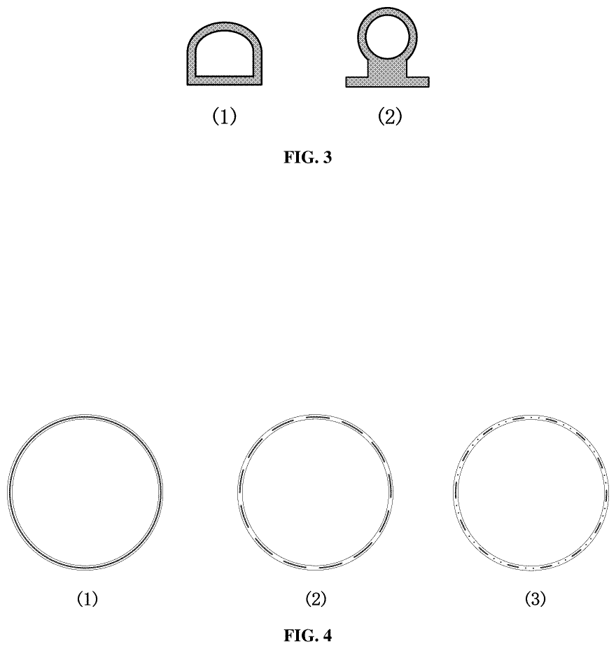

As shown in FIG. 2, the thermal insulation board may include a single-layer hollow insulation board 15, a two-layer hollow insulation board 16, a low-density foamed porous board 17, and a high-density foamed porous board 18. As shown in FIG. 3, the sealing strip may be a D-shaped sealing strip or a a-shaped sealing strip. As shown in FIG. 4, a hollow cavity of the sealing strip may be filled with magnetic rods continuously throughout the circumference, may be filled with long magnetic rods at intervals throughout the circumference, or may be filled with short magnetic rods at intervals throughout the circumference.

During heat storage, the hot water prepared by the heat source flows through the hot water valve 12 and enters the tank evenly through the first water distributor 6. At the same time, the cold water at the bottom of the tank flows out from the second water distributor 7 through the cold water valve 14 and enters the hot fluid source. The thermal insulation board in the tank is at the junction of the hot and cold water, and a thermocline moves down synchronously.

During cold storage, the cold water prepared by a refrigerator flows through the cold water valve 14 and evenly enters the tank through the second water distributor. At the same time, the hot water in the upper part of the tank flows out through the first water distributor 6 and enters the refrigerator. The thermal insulation board in the tank is at the junction of the hot and cold water, and the thermocline moves up synchronously.

### Example 1

The thermal insulation board is a polycarbonate endurance board, which is a circular and two-layer hollow board, as shown in (2) of FIG. 2. The frame is 1.5 mm thick, and the thermal insulation board is 15 mm thick. A Ω-shaped silicone foam sealing strip is used at the edge, as shown in (2) of FIG. 3. The sealing strip is pasted to the thermal insulation board body by using hot melt adhesive. The Φ5×50 mm (diameter×length) neodymium iron boron (NdFeB) magnet (N45M, 7.5 g/cm³) rods with a heat-resistant temperature of 100° C. are continuously filled and arranged on the sealing strip around the entire circumference of the thermal insulation board, as shown in (1) of FIG. 4. The number of the magnet rods is selected based on the density of the hot and cold water in the hot water tank, the gravity of the polycarbonate endurance board, and buoyancy, so that the friction between the sealing strip and the wall under the buoyancy, gravity, and magnetic force allows the thermal insulation board to stay at the junction of the cold and hot fluids, and move up and down with the hot and cold fluids. The magnetic force enables the sealing strip to be tightly attached to the inner wall of the tank.

### Example 2

The thermal insulation board is a polycarbonate endurance board, which is a circular and one-layer hollow board, as shown in (1) of FIG. 2. The frame is 2 mm thick, and the thermal insulation board is 10 mm thick. A D-shaped silicone foam sealing strip is used at the edge, as shown in (1) of FIG. 3. The sealing strip is pasted to the thermal insulation board body by using hot melt adhesive. The 100 mm×10 mm×2 mm (length×width×height) NdFeB magnet (N45, 7.5 g/cm³) rods with a heat-resistant temperature of 80° C. are filled in the hollow part of the sealing strip around the entire circumference of the thermal insulation board, as shown in (2) of FIG. 4. The number of the magnet rods is selected based on the density of the hot and cold water in the hot water tank, the gravity of the polycarbonate endurance board, and buoyancy, so that the friction between the sealing strip and the wall under the buoyancy, gravity, and magnetic force allows the thermal insulation board to stay at the junction of the cold and hot fluids, and move up and down with the hot and cold fluids. The magnetic force enables the sealing strip to be tightly attached to the inner wall of the tank.

### Example 3

The thermal insulation board is a circular low-density silicone foam porous board. Its structure is shown in (3) of FIG. 2. The thermal insulation board is 10 mm thick. A D-shaped silicone foam sealing strip is used at the edge, as shown in (1) of FIG. 3. The sealing strip is pasted to the thermal insulation board body by using hot melt adhesive. The 50 mm×10 mm×2 mm (length×width×height) NdFeB magnet (N45, 7.5 g/cm³) rods with a heat-resistant temperature of 80° C. are filled at intervals on the sealing strip around the entire circumference of the thermal insulation board, as shown in (3) of FIG. 4. The number of the magnet rods is selected based on the density of the hot and cold water in the hot water tank, the gravity of the low-density silicone foam porous board, and buoyancy, so that the friction between the sealing strip and the wall under the buoyancy, gravity, and magnetic force allows the thermal insulation board to stay at the junction of the cold and hot fluids, and move up and down with the hot and cold fluids. The magnetic force enables the sealing strip to be tightly attached to the inner wall of the tank.

### Example 4

The thermal insulation board is a circular high-density silicone foam porous board. Its structure is shown in (4) of FIG. 2. The thermal insulation board is 15 mm thick. A Ω-shaped silicone foam sealing strip is used at the edge, as shown in (2) of FIG. 3. The sealing strip is seamed to the thermal insulation board body. The Φ05×50 mm (diameter×length) NdFeB magnet (SmCo5, 7.5 g/cm³) rods with a heat-resistant temperature of 250° C. are continuously filled in the hollow part of the sealing strip around thermal insulation board, as shown in (1) of FIG. 4. The number of the magnet rods is selected based on the density of the hot and cold water in the hot water tank, the gravity of the high-density silicone foam porous board, and buoyancy, so that the friction between the sealing strip and the wall under the buoyancy, gravity, magnetic force, and friction allows the thermal insulation board to stay at the junction of the cold and hot fluids, and move up and down with the hot and cold fluids. The magnetic force enables the sealing strip to be tightly attached to the inner wall of the tank.

The foregoing is merely illustrative of the preferred examples of the present invention and is not intended to limit the present invention, and various changes and modifications may be made by those skilled in the art. Any modifications, equivalent substitutions, improvements, etc. made within the spirit and scope of the present invention should be included within the protection scope of the present invention.

What is claimed is:

1. A device for flexibly separating cold and hot fluid media, comprising:
a tank body, wherein the tank body is cylindrical and disposed vertically; upper and lower ends of the tank body are respectively provided with a hot fluid inlet and a cold fluid inlet to provide storage space for hot and cold fluids; at least one adsorption layer is provided on a side wall of the tank body, and the adsorption layer is made of a ferromagnetic material or iron; and
a thermal insulation board, wherein the thermal insulation board is of a plate structure and set on a horizontal cross-section of the tank body, with a shape and area matching a horizontal cross-section of the tank body; wherein
a sealing strip is arranged along a circumferential direction of the thermal insulation board, the sealing strip is of a hollow structure, and the hollow part is evenly filled with adsorption blocks, the adsorption blocks are made of a ferromagnetic material or iron, and attraction is generated between the adsorption layer and the adsorption blocks; and
a working surface area of the body of the thermal insulation board is smaller than the horizontal cross-section of the tank body.

2. The device for flexibly separating cold and hot fluid media according to claim 1, wherein the hot fluid inlet is provided with a first water distributor, the cold fluid inlet is provided with a second water distributor, and the first water distributor and the second water distributor are respectively connected to a hot fluid source and a cold fluid source;
further, both the first water distributor and the second water distributor are coaxial with the tank body.

3. The device for flexibly separating cold and hot fluid media according to claim 1, wherein a thickness of the thermal insulation board ranges from 5 mm to 100 mm.

4. The device for flexibly separating cold and hot fluid media according to claim 1, wherein the thermal insulation board has a heat conductivity coefficient ranging from 0.02 W to 0.5 W/(m·K), and is resistant to a low temperature of −60° C. and a high temperature of 250° C.;
further, the thermal insulation board is a polycarbonate endurance board or a silicone foam board.

5. The device for flexibly separating cold and hot fluid media according to claim 1, wherein the material of the sealing strip is elastic;
further, the sealing strip is a silicone foam sealing strip, and a cross-section area of the hollow part of the sealing strip is larger than a cross-section area of the adsorption block.

6. The device for flexibly separating cold and hot fluid media according to claim 1, wherein a surface of the sealing strip in contact with the side wall of the tank body is a curved surface.

7. The device for flexibly separating cold and hot fluid media according to claim 1, wherein the sealing strip is attached to the board body through one or any combination of hot melting, impaction, gluing, seam, snap-fit, or screwing.

8. The device for flexibly separating cold and hot fluid media according to claim 1, wherein the ferromagnetic material is a neodymium iron boron magnet or a samarium cobalt magnet.

9. The device for flexibly separating cold and hot fluid media according to claim 8, wherein the adsorption block is a flexible magnet strip.

10. The device for flexibly separating cold and hot fluid media according to claim 1, wherein the adsorption blocks are arranged along the circumferential direction of the thermal insulation board to completely cover the circumference of the thermal insulation board, or are evenly distributed along the circumferential direction of the thermal insulation board and cover more than ⅓ of the circumference of the thermal insulation board.
